(19) United States
(12) Patent Application Publication
(10) Pub. No.: US 2008/0087051 A1
(43) Pub. Date: Apr. 17, 2008

(54) Door lock and drive tube assembly thereof

(75) Inventor: Chia-Chi Huang, Ziguan Shiang (TW)

Correspondence Address: TROXELL LAW OFFICE PLLC;SUITE 1404, 5205 LEESBURG PIKE, FALLS CHURCH, VA, 22041, US

(73) Assignee: Taiwan Fu Hsing Industrial Co., Ltd.

(21) Appl. No.: 11/545,776

(22) Filed: Oct. 11, 2006

(51) Int. Cl. E05B 65/06

(52) U.S. Cl. 70/91

(57) ABSTRACT

A door lock and drive tube assembly thereof comprises a first handle assembly, a second handle assembly and a lock releasing assembly. The first handle assembly has a handle, a spindle, a catch and a drive tube assembly. The handle has a hollow coupling portion and the hollow coupling portion has an access opening. The spindle is attached to the hollow coupling portion of the handle. The catch is installed in the spindle and has an engagement head, and the engagement head is selectively disposable within the access opening of the handle. The drive tube assembly is installed within the spindle and has a stop member to prevent the engagement head of the catch disengaging from the access opening. The second handle assembly corresponds to the first handle assembly. The lock releasing assembly is installed between the first handle assembly and the second handle assembly and includes a rod to push the stop member of the drive tube assembly so as to block the catch.

### FIELD OF THE INVENTION

The present invention is generally relating to a lock device, more particularly to a door lock and drive tube assembly thereof having stop member.

### BACKGROUND OF THE INVENTION

Referring to FIG. 1 and FIG. 2, a well-known lock device 10 comprises a first handle assembly 11, a second handle assembly 12 and a lock releasing assembly 13. The first handle assembly 11 and the second handle assembly 12 are oppositely installed at the inside and outside of a door plank 30 respectively, and the lock releasing assembly 13 is installed between the first handle assembly 11 and the second handle assembly 12. The first handle assembly 11 has a handle 111, a spindle 112, a catch 113 installed in the spindle 112 and a drive tube assembly 114, the handle 111 has an access opening 111A, the spindle 112 is attached to the handle 111, the catch 113 protrudes to the spindle 112 and engages with the access opening 111A to prohibit the handle 111 from being pulled out, and the drive tube assembly 114 is installed inside the spindle 112 to drive a retractor 131 of the lock releasing assembly 13 for unlocking. However, the lock device 10 mentioned above is not suitable for being a veranda lock, the reason will be explained as follows with referring to FIG. 3 and FIG. 4. While in a locked position, the drive tube assembly 114 is merely used to prevent the retractor 131 of the lock releasing assembly 13 from being driven to unlock, so that while a burglar wants to enter house from outside of the door plank 30, he only needs a push member 40 to push the catch 113 of the first handle assembly 11 allowing the catch 113 to disengage from the access opening 111A of the handle 111 and then the handle 111 can be removed to expose the spindle 112 and the drive tube assembly 114 thereby turning the drive tube assembly 114 to drive the retractor 131 to unlock. Accordingly, the lock device 10 cannot prohibit the burglar from entering house without burglarproof function.

### SUMMARY OF THE INVENTION

In order to solve the problem mentioned above, the main object of the present invention is to provide a door lock and drive tube assembly thereof, in which a stop member is installed in a drive tube assembly to enable the stop member to block a catch during locking process to prevent the catch disengaging from access opening of a handle, and then avoid the handle from being pulled out and exposing the drive tube assembly so as to obtain substantial burglarproof function.

A door lock in accordance with the present invention comprises a first handle assembly, a second handle assembly and a lock releasing assembly. The first handle assembly has a handle, a spindle, a catch and a drive tube assembly. The handle has a hollow coupling portion and the hollow coupling portion also has an access opening, the spindle is attached to the hollow coupling portion of the handle. The catch installed in the spindle has an engagement head which is selectively disposable within the access opening. The drive tube assembly installed within the spindle has a stop member, when one block end of the stop member is pushed to outside of the drive tube assembly, the stop member may prohibit the engagement head of the catch disengaging from the access opening. The second handle assembly corresponds to the first handle assembly and the lock releasing assembly installed between the first handle assembly and the second handle assembly includes a rod being used to push the stop member of the drive tube assembly to block the catch so as to prohibit the engagement head of the catch disengaging from the access opening.

A drive tube assembly of a door lock in accordance with the present invention comprises a shaft tube, a stop member, a resilient member and a movable member. The shaft tube further comprises a retaining plate formed at one end of the shaft tube and has a through hole formed on the retaining plate, and the stop member is installed within the shaft tube and corresponds to the through hole. The resilient member is installed between the retaining plate and the stop member, and the movable member is installed corresponding to the retaining plate to limit the stop member and the resilient member in the shaft tube.

A combination structure of spindle and drive tube assembly of a door lock in accordance with the present invention comprises a spindle, a catch and a drive tube assembly. The catch installed in the spindle has an engagement head. The drive tube assembly installed within the spindle has a stop member to block the catch.

### DESCRIPTION OF THE DRAWINGS

FIG. 1 is a perspective exploded diagram of a well-known lock device.

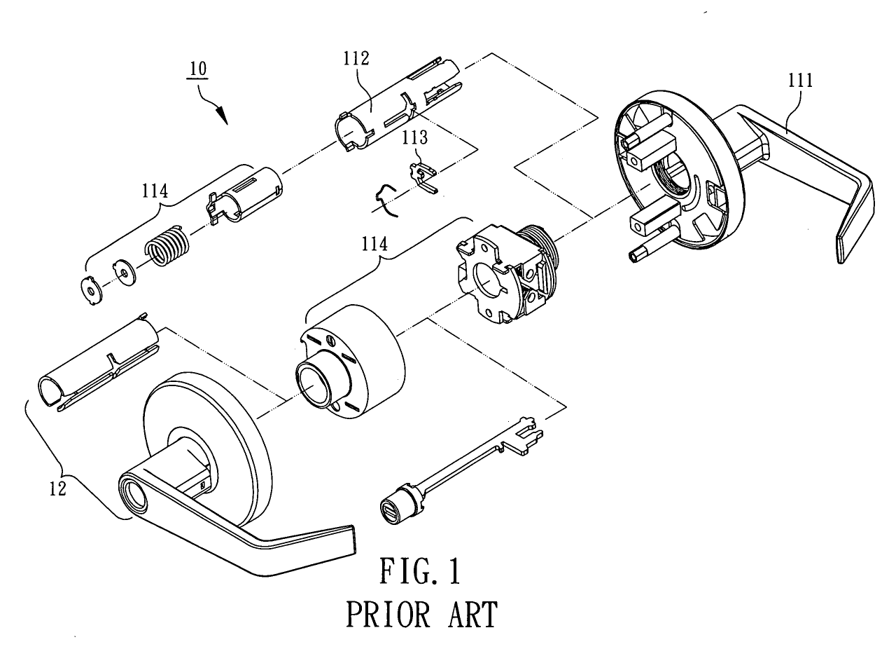

FIG. 2 is a cross-sectional diagram of the well-known lock device.

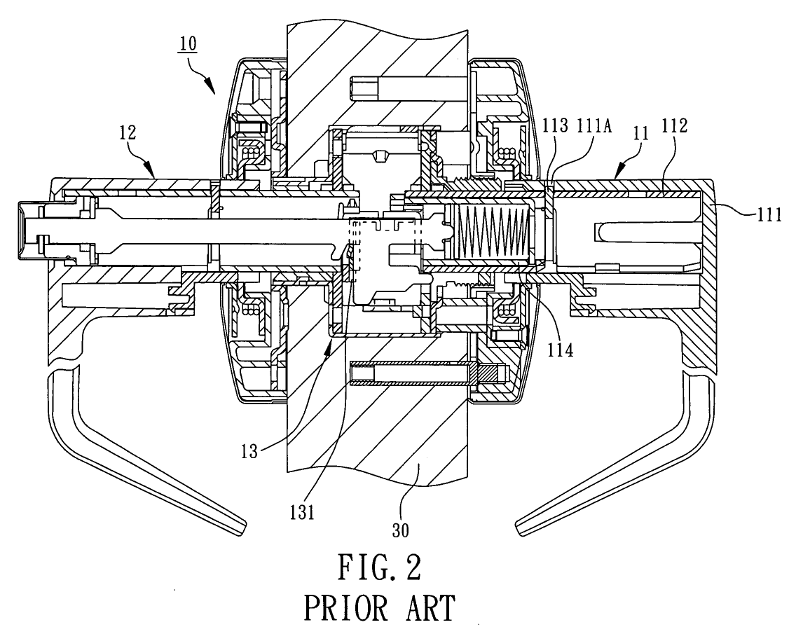

FIG. 3 is a diagram illustrating working process of the well-known lock device.

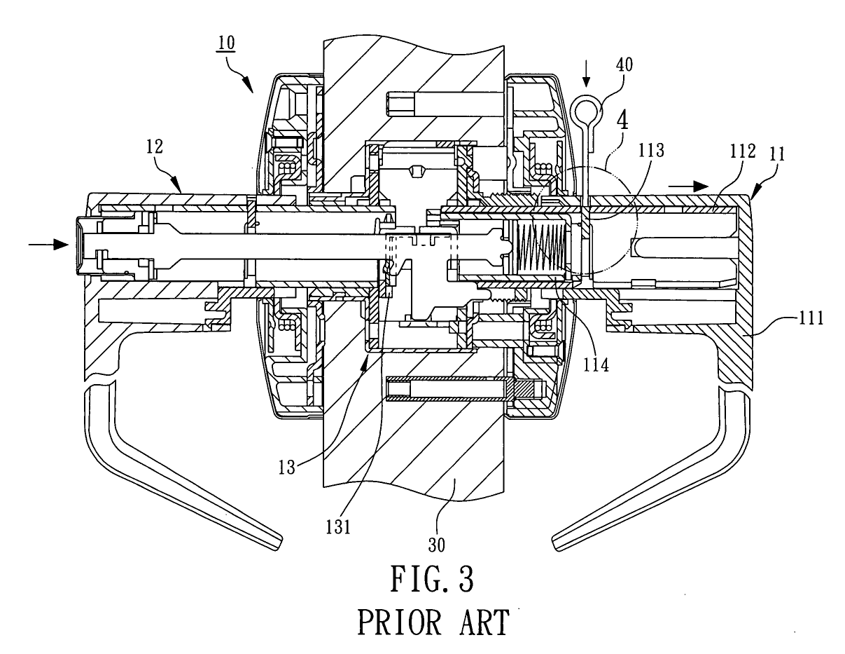

FIG. 4 is a partially enlarged diagram of the well-known lock device.

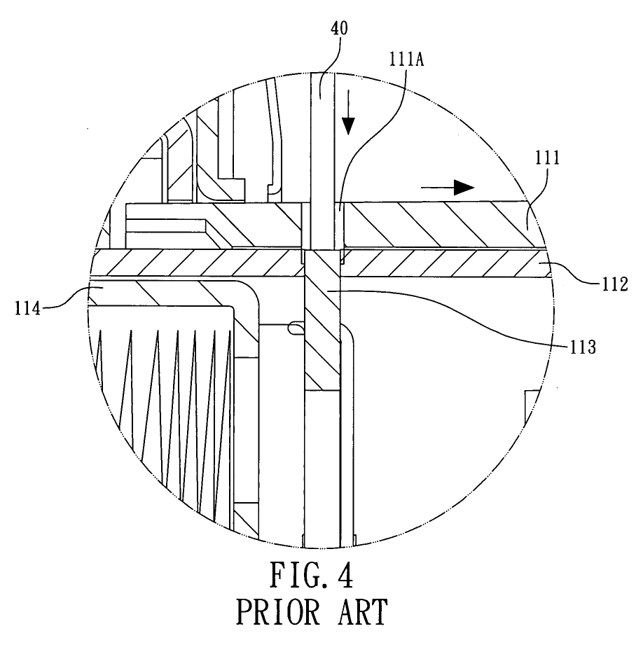

FIG. 5 is a perspective exploded diagram of a door lock in accordance with a preferred embodiment of the present invention.

FIG. 6 is a perspective exploded diagram of drive tube assembly of a door lock in accordance with a preferred embodiment of the present invention.

FIG. 7 is a cross-sectional diagram of a door lock in accordance with a preferred embodiment of the present invention.

FIG. 8 is a diagram illustrating working progress of a door lock in accordance with a preferred embodiment of the present invention.

FIG. 9 is a partially enlarged diagram of a door lock in accordance with a preferred embodiment of the present invention.

### DETAILED DESCRIPTION OF THE INVENTION

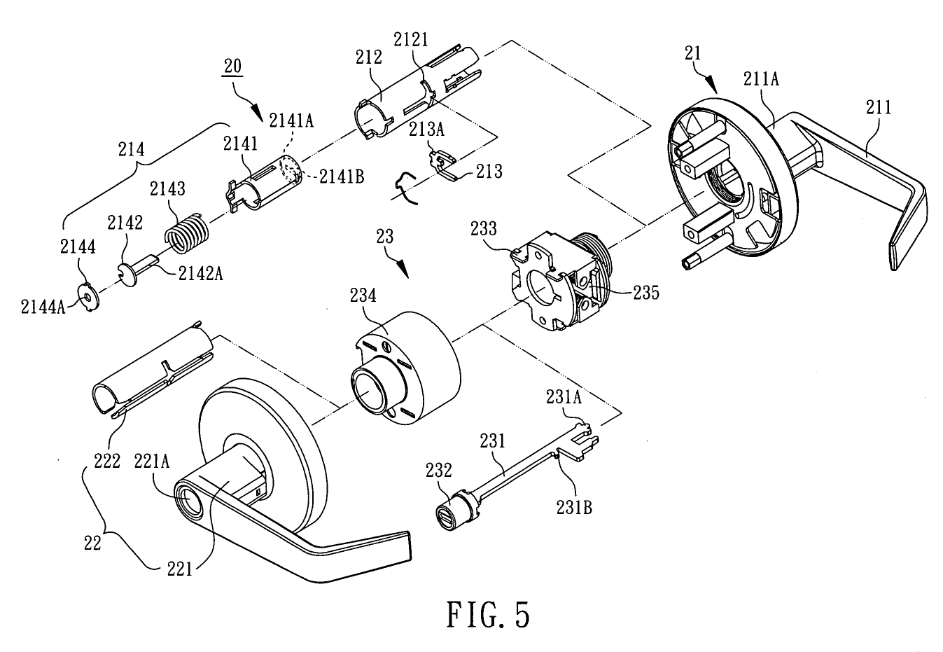

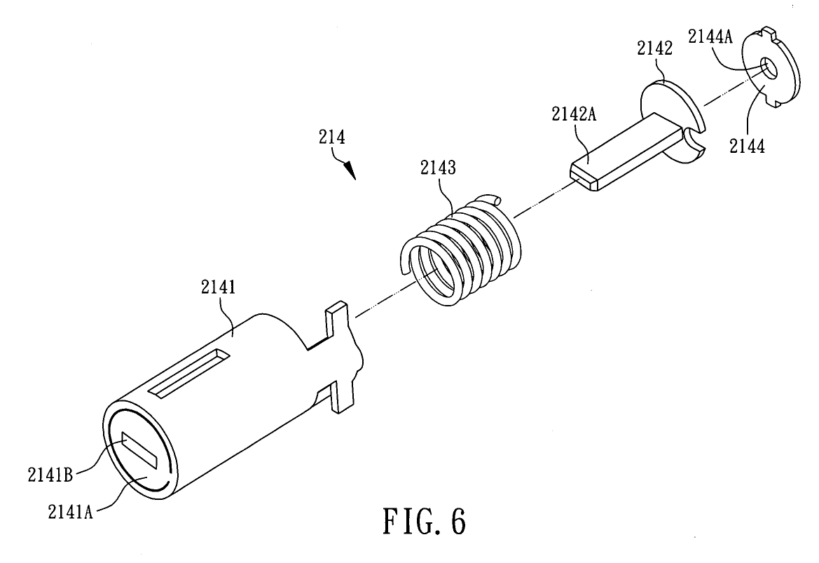

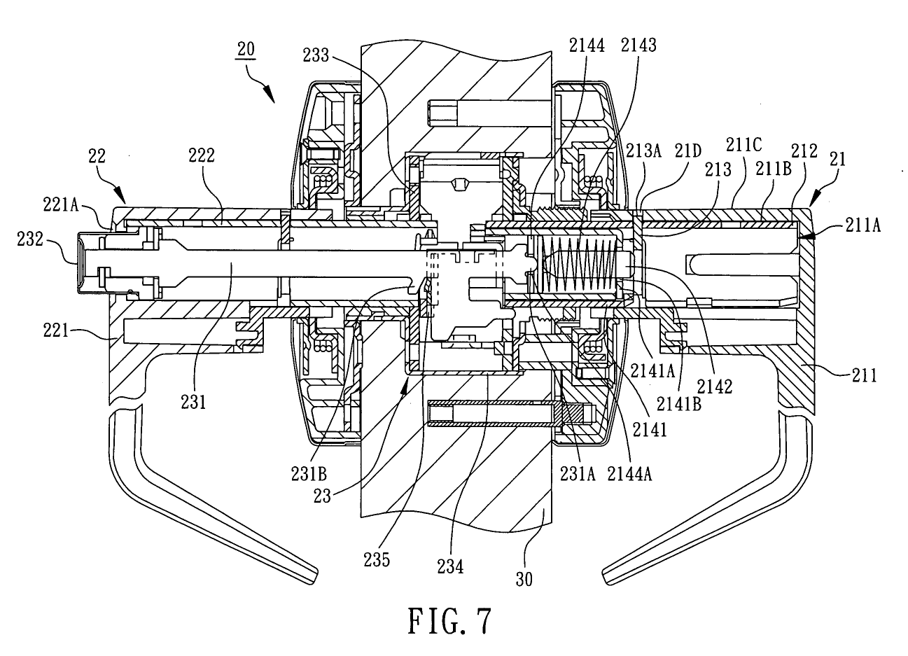

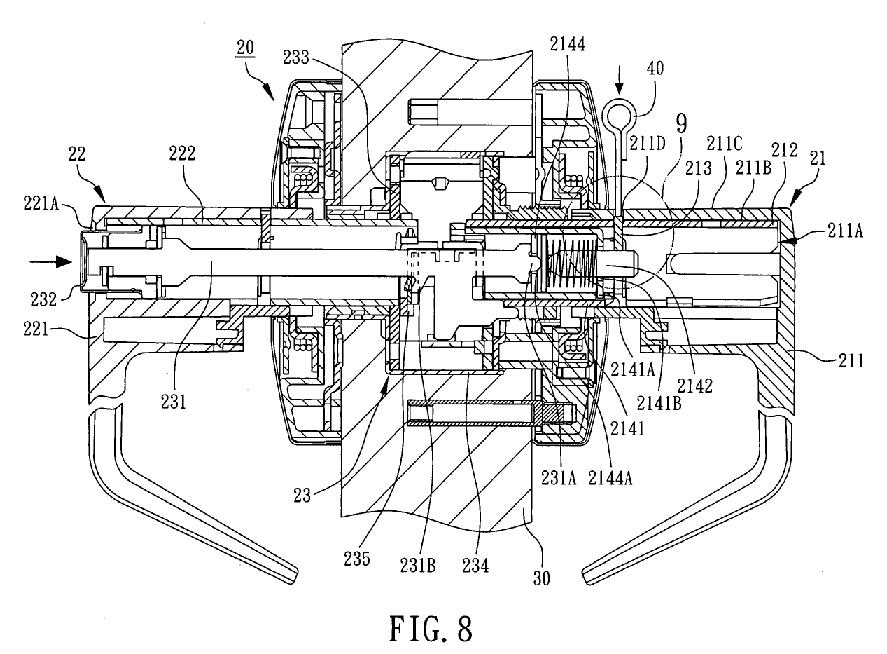

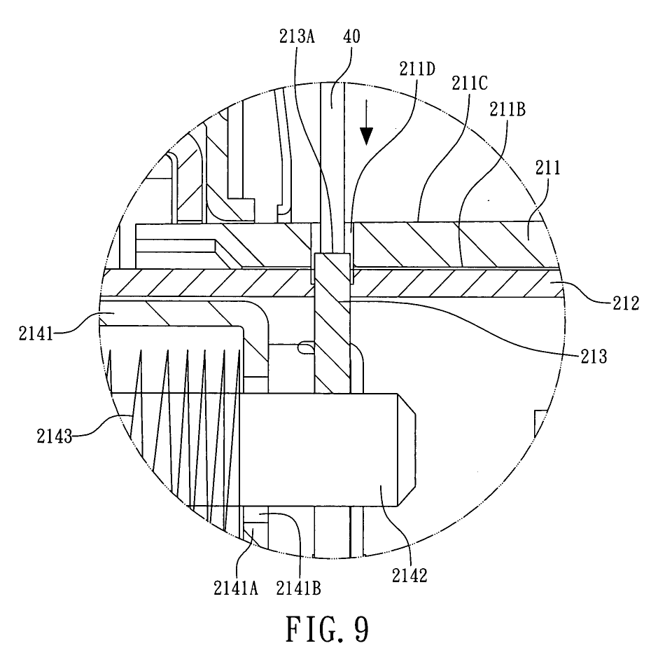

Referring to FIGS. 5, 6, 7 and 8, therein is showed a door lock 20 in accordance with a preferred embodiment of the present invention comprising a first handle assembly 21, a second handle assembly 22 and a lock releasing assembly 23. The first handle assembly 21 has a handle 211, a spindle 212, a catch 213 installed in the spindle 212 and a drive tube assembly 214, and the handle 211 has a hollow coupling portion 211A. Referring to FIG. 7, the hollow coupling portion 211A has an inside wall 211B, an outside wall 211C and an access opening 211D formed on the hollow coupling portion 211A. The spindle 212 that is attached to the hollow coupling portion 211A of the handle 211 has a catch hole 2121 and the catch 213 has an engagement head 213A which is disposable within the catch hole 2121 and corresponds to the access opening 211D. The engagement head 213A is selectively disposable within the access opening 211D to prohibit the handle 211 from being pulled out by an external force. The drive tube assembly 214 is installed within the spindle 212 and limited by the catch 213. In this embodiment, the drive tube assembly 214 has a shaft tube 2141, a stop member 2142, a resilient member 2143 and a movable member 2144. The shaft tube 2141 further comprises a retaining plate 2141A formed at one end of the shaft tube 2141 and has a through hole 2141B formed on the retaining plate 2141A. The stop member 2142 installed within the shaft tube 2141 has a block end 2142A such as a flat tail corresponding to the through hole 2141B of the retaining plate 2141A and serves to block the catch 213 so as to prevent the engagement head 213A of the catch 213 disengaging from the access opening 211D by inserting a push member 40 into the access opening 211D to push the engagement head 213A (referring to FIGS. 8 and 9), in this embodiment, the stop member 2142 can be pushed by the push member 40 to enable the block end 2142A (as the flat tail) to project into the through hole 2141B and beneath the catch 213 so as to block the catch 213. The resilient member 2143 may be a spring and is installed between the retaining plate 2141A and the stop member 2142. The movable member 2144 is installed corresponding to the retaining plate 2141A to limit the stop member 2142 and the resilient member 2143 in the shaft tube 2141. In this embodiment, the stop member 2142 and the movable member 2144 can move repeatedly inside the shaft tube 2141. Preferably, the stop member 2142 and the movable member 2144 can be formed integrally.

The second handle assembly 22 corresponding to the first handle assembly 21 has a handle 221 and a hollow spindle 222. The handle 221 has an opening 221A and the hollow spindle 222 is attached to the handle 221. The lock releasing assembly 23 installed between the first handle assembly 21 and the second handle assembly 22 includes a rod 231, a push-button 232, a first fixing seat 233 and a second fixing seat 234. The rod 231 is installed penetrating the first fixing seat 233, the second fixing seat 234 and the hollow spindle 222 of the second handle assembly 22 and capable of pushing the stop member 2142 of the drive tube assembly 214. In this embodiment, the rod 231 has a protruding end 231A, the movable member 2144 has a through hole 2144A, and the protruding end 231A penetrates into the through hole 2144A. The push-button 232 is attached to the rod 231 and installed in the opening 221A of the handle 221. When the rod 231 is pushed by the push-button 232, it moves to push the stop member 2142 and the movable member 2144 of the drive tube assembly 214 that allows the block end 2142A of the stop member 2142 to move out of the drive tube assembly 214 and beneath the catch 213. In this embodiment, the block end 2142A of the stop member 2142 penetrates the through hole 2141B of the retaining plate 2141A to block the catch 213 that prohibits the catch 213 disengaging from the access opening 211D of the handle 211.

Referring to FIGS. 8, 9, therein is showed about locking and unlocking actions of the door lock 20. First, the first handle assembly 21 and the second handle assembly 22 are corresponding to each other installed at the outside and inside of a door plank 30 respectively. While a locking process is proceeded from inside of the door plank 30, the push-button 232 of the lock releasing assembly 23 is pushed to make the rod 231 transversely move. Then, a hook portion 231B of the rod 231 moves to inside of a retractor 235 and is limited at the retractor 235. While the rod 231 moves, it simultaneously pushes the stop member 2142 of the drive tube assembly 214 to make the block end 2142A penetrate the through hole 2141B and move to beneath the catch 213 to block the catch 213 that enables the engagement head 213A of the catch 213 not to disengage from the access opening 211D of the handle 211 even if a push comes from the push member 40. As a result, it can be prevented that the handle 211 at outside of the door plank 30 is pulled out to expose the spindle 212 and the drive tube assembly 214 thereby achieving burglarproof purpose. Moreover, while an unlocking process is proceeded from inside of the door plank 30, it merely needs to turn the handle 221 to indirectly drive the drive tube assembly 214 to rotate. Then, while the drive tube assembly 214 rotates, it simultaneously drives the retractor 235 to release the limitation of the hook portion 231A of the rod 231. Next, due to a push from the resilient member 2143 of the drive tube assembly 214, the stop member 2142 in a position of blocking the catch 213 restores into the drive tube assembly 214. Thus, by means of a push again from the push member 40 the engagement head 213A of the catch 213 may disengage from the access opening 211D and then the rod 231 and the push-button 232 also restore following the restoration of the stop member 2142 to complete the entire unlocking action.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A door lock comprising:
a first handle assembly comprising:
a handle having a hollow coupling portion, the hollow coupling portion having an inside wall, an outside wall and an access opening formed on the hollow coupling portion;
a spindle attached to the hollow coupling portion of the handle;
a catch having an engagement head installed in the spindle, the engagement head is selectively disposable within the access opening of the handle; and
a drive tube assembly installed within the spindle, the drive tube assembly having a stop member being used to block the catch;
a second handle assembly corresponding to the first handle assembly; and
a lock releasing assembly installed between the first handle assembly and the second handle assembly, the lock releasing assembly includes a rod being used to push the stop member of the drive tube assembly to block the catch so as to prohibit the engagement head of the catch disengaging from the access opening.

2. The door lock in accordance with claim 1, wherein the spindle has a catch hole and the engagement head of the catch is disposable within the catch hole of the spindle.

3. The door lock in accordance with claim 1, wherein the drive tube assembly further comprises a shaft tube, a resilient member and a movable member.

4. The door lock in accordance with claim 3, wherein the shaft tube further comprising a retaining plate formed at one end of the shaft tube and having a through hole formed on the retaining plate.

5. The door lock in accordance with claim 4, wherein the stop member is installed within the shaft tube and has a flat tail corresponding to the through hole of the retaining plate.

6. The door lock in accordance with claim 4, wherein the resilient member is installed between the retaining plate and the stop member.

7. The door lock in accordance with claim 1, wherein the rod pushes the stop member to move out of the drive tube assembly and beneath the catch so as to block the catch.

8. The door lock in accordance with claim 7, further comprising a push-button attached to the rod that may push the rod to make the rod move.

9. Combination structure of spindle and drive tube assembly of a door lock comprising:
a spindle;
a catch having an engagement head installed in the spindle; and
a drive tube assembly installed within the spindle, the drive tube assembly comprising:
a shaft tube having a retaining plate formed at one end of the shaft tube and having a through hole formed on the retaining plate;
a stop member having a flat tail installed within the shaft tube, the flat tail of the stop member corresponds to the through hole; and
a resilient member installed between the retaining plate and the stop member,
wherein the stop member can be pushed to enable the flat tail to project into the through hole and beneath the catch so as to block the catch.

10. The combination structure of spindle and drive tube assembly of a door lock in accordance with claim 9, wherein the spindle has a catch hole and the engagement head of the catch is disposable within the catch hole of the spindle.
